(19) United States
(12) Patent Application Publication
(10) Pub. No.: US 2018/0039245 A1
(43) Pub. Date: Feb. 8, 2018

(54) PROCESS INTERRUPT DEVICE

(71) Applicant: Reacy H. Hobbs, Chicago, IL (US)

(72) Inventor: Reacy H. Hobbs, Chicago, IL (US)

(21) Appl. No.: 15/227,360

(22) Filed: Aug. 3, 2016

(51) Int. Cl. G05B 19/048; B65G 15/00; B65G 43/00; G05B 9/02

(52) U.S. Cl. CPC G05B 19/048; G05B 9/02; B65G 15/00; B65G 43/00; G05B 2219/14116

(57) ABSTRACT

A user carried remote control interrupt transmitter that communicates with an interrupt receiver configured with a stop line circuit of a manufacturing process, such as a conveyor interrupt circuit. The remote control interrupt transmitter permits a user performing tasks associated with the manufacturing process to activate the stop line circuit from any location in the vicinity of the manufacturing process.

### BACKGROUND OF THE INVENTION

The present invention relates to process interrupt devices and, more particularly to process interrupt devices for manufacturing process to improve worker and equipment safety.

While great strides have been made in improving the safety of manufacturing process, thousands of workers are killed or injured each year, as a result of preventable manufacturing process accidents. In addition to the human toll represented by such accidents, substantial costs in terms of downtime and associated property damage for the companies may be incurred.

A continuing source of manufacturing process accidents is conveyor systems and the ability to stop the conveyor in time to prevent an injury or property damage. While many systems have interrupt switches incorporated with the systems, the interrupt switch is typically located at a fixed location and may not be immediately accessible by workers performing tasks at various locations along the conveyor.

As can be seen, there is a need for an improved process interrupt system that is immediately accessible to workers.

### SUMMARY OF THE INVENTION

In one aspect of the present invention, a manufacturing process interrupt control system, includes: a remote control adapted to be carried on the person of a user and configured to transmit an interrupt control signal responsive to the user's activation of an interrupt control button carried by the remote control; an interrupt control receiver configured to receive the interrupt control signal; and an interrupt receiver connection circuit configured to communicate the interrupt control signal from the interrupt control receiver to a stop line circuit of the manufacturing process. Preferably, the remote control transmitter is a multi-code transmitter and the interrupt control receiver is a multi-code receiver. In some embodiments, a plurality of multi-code transmitters are coded to communicate with the multi-code receiver. In some systems, the manufacturing process is a conveyor system.

In other aspects of the invention, a plurality of multi-code receivers, are each configured to connect with the stop line circuit of a plurality of discrete manufacturing processes, wherein each of the multi-code receivers is coded with a discrete code. Similarly, a set of multi-code transmitters may be coded to communicate with at least one of the plurality of multi-code receivers.

These and other features, aspects and advantages of the present invention will become better understood with reference to the following drawings, description and claims.

### BRIEF DESCRIPTION OF THE DRAWINGS

FIG. 1 is a perspective view of an embodiment of the invention shown in use;

FIG. 2 is an electrical schematic of an interrupt circuit;

FIG. 3 is an electrical schematic of an interrupt circuit; and

FIG. 4 is an electrical schematic of an interrupt circuit.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a remote control interrupt switch that is carried by a user operating in close proximity to a manufacturing process. The remote control interrupt switch may be activated by one of a plurality of users to stop the manufacturing process in the event of a safety related event.

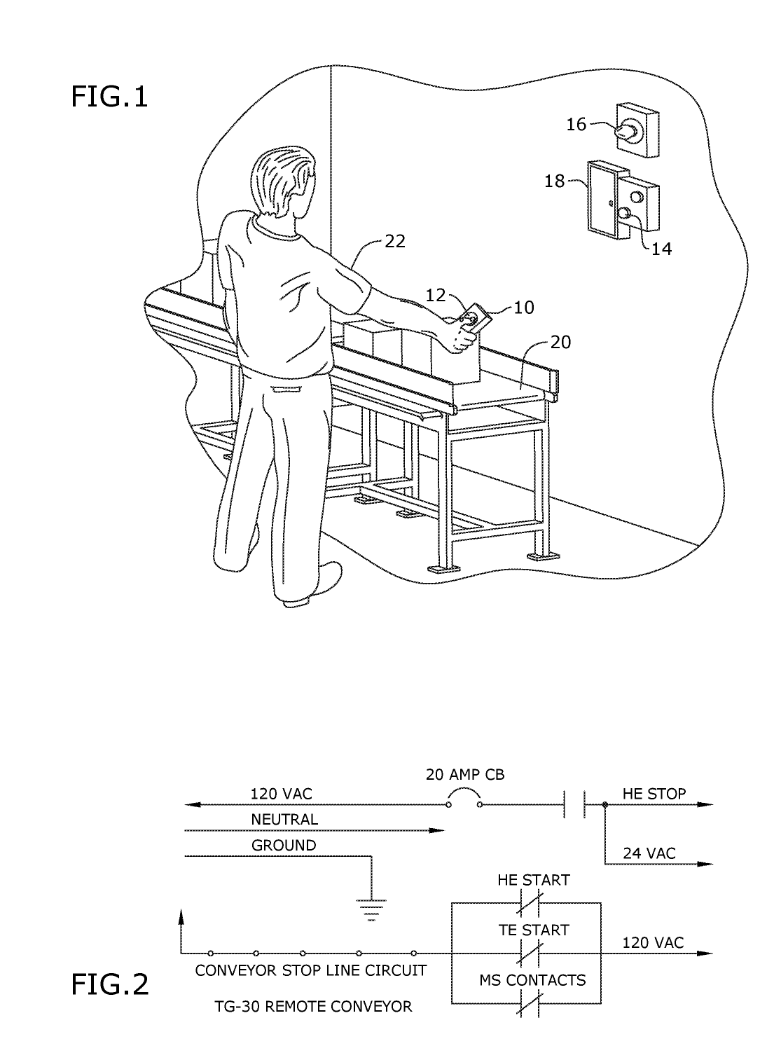

As seen in reference to FIG. 1, a manufacturing process, such as a conveyor belt 20 operation, is illustrated incorporating aspects of the present invention. In current systems, the conveyor 20 is provided with a stop line circuit that has an emergency interrupt button 14, which is typically located at a fixed position in proximity to the manufacturing process. For example the emergency interrupt button 14 may be mounted to a wall in close proximity to the conveyor 20, yet not readily accessible to one or more workers 22 performing tasks in proximity to the conveyor 20. The system may also include a warning light 16 which may be illuminated in the event of an emergency or illuminated during operation of the conveyor 20 show the operational status of the conveyor 20 and to facilitate a user with locating the button 14 in the event of an emergency situation.

According to preferred aspects of the invention, a conventional process interrupt system is augmented by the addition of a remote controller 10 having a system interrupt control 12, such as a stop button. The remote controller 10 includes a transmitter that is in communication with an interrupt receiver 18 at least upon activation of the system interrupt control 12.

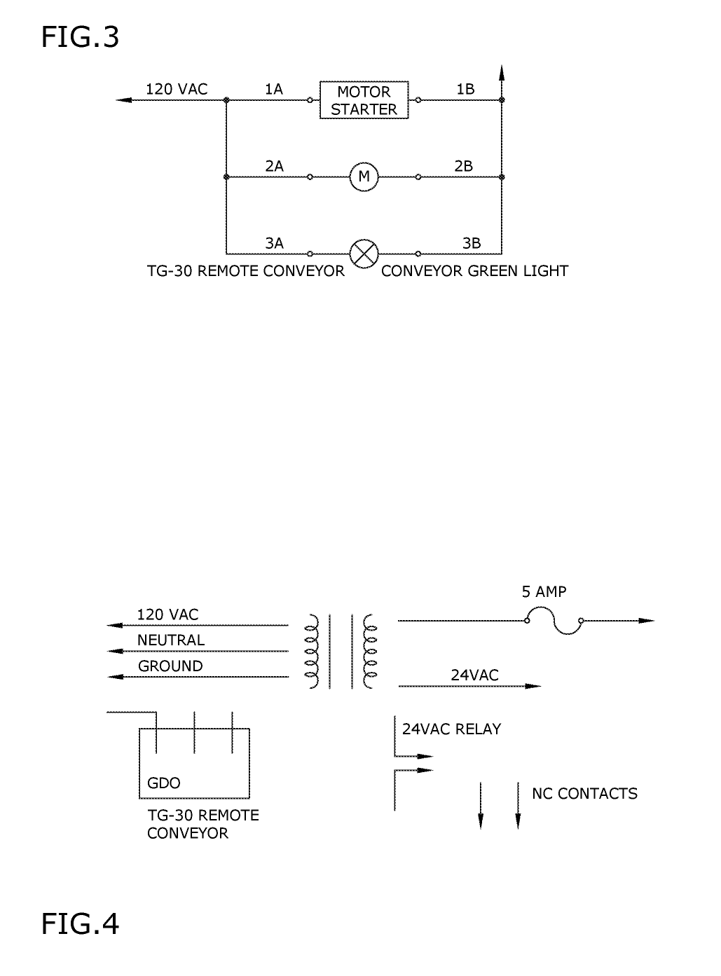

As seen in reference to FIGS. 2-4, the interrupt receiver 18 is configured with the stop line control circuitry of a manufacturing process interrupt system. In a non-limiting representative embodiment of the system, the remote controller 10 may be a hand held garage door opener transmitter, which may be a multi-code garage door opener. The receiver 18 may be the associated receiver of a garage door opener interconnected to control the stop line circuit 14 of the existing conveyor system. The present invention works by inserting a radio frequency garage door opener into the emergency stop line circuit of a conveyor 20. This is a very simple and extremely easy implementation of a safety process improvement.

In a facility where multiple processes are controlled, the remote controllers 10 for the workers 22 associated or assigned to a particular process may each be coded to communicate with the interrupt receiver 18 associated with that particular process. Workers 22 assigned to a different process may have controllers 10 coded with the receiver 18 for that process to interrupt only the associated process.

In operation, a remote interrupt system functions as a watch dog safety feature in conjunction with the conveyor's 20 own stop line circuitry. The interrupt receiver 18 has a set of normally closed contacts added to the conveyor's existing circuitry. The interrupt receiver 18 can be integrated into the conveyor's stop line circuitry with an interrupt receiver connection circuitry, including a low voltage transformer, which may be a 24 volt ac transformer, a low voltage relay, such as 24 volt ac relay, a fuse, which may be a 5 amp fuse, and a contact, which may be normally open contacts operatively connected as a circuit with the motor starter of the conveyor belt 20.

When the interrupt receiver 18 receives a signal from the remote control 10, upon activation of the interrupt button 12, the normally closed contact will reverse states and open. This causes the conveyor 20 to stop because the conveyor control circuitry has received the equivalent of a manual stop signal.

The interrupt receiver 18 works as follows: after the interrupt receiver connection circuitry has been to the manufacturing process interrupt circuitry, the employees 22 are given a hand held remote control 10, which can be attached to their person via a pouch, holster, lanyard, or the like. Whenever the needs arises, the employee 22 will activate the interrupt button 12 on the remote control 10, which sends an interrupt signal to the interrupt receiver 18. Responsive to receipt of the interrupt signal, power to the conveyor motor will be interrupted, and the conveyor 20, or other manufacturing process will stop.

As will be appreciated, while an embodiment of the present invention is illustrated with respect to a conveyor 20, the interrupt system of the present invention can also be used to control any machine or process that has a conventional stop line circuitry.

It should be understood, of course, that the foregoing relates to exemplary embodiments of the invention and that modifications may be made without departing from the spirit and scope of the invention as set forth in the following claims.

What is claimed is:

1. A manufacturing process interrupt control system, comprising:
a remote control adapted to be carried on the person of a user and configured to transmit an interrupt control signal responsive to the user's activation of an interrupt control button carried by the remote control;
an interrupt control receiver configured to receive the interrupt control signal; and
an interrupt receiver connection circuit configured to communicate the interrupt control signal from the interrupt control receiver to a stop line circuit of the manufacturing process.

2. The system of claim 1, wherein the remote control transmitter is a multi-code transmitter.

3. The system of claim 2, wherein the interrupt control receiver is a multi-code receiver.

4. The system of claim 3, wherein a plurality of multi-code transmitters are coded to communicate with the multi-code receiver.

5. The system of claim 4, wherein the manufacturing process is a conveyor system.

6. The system of claim 4, further comprising:
a plurality of multi-code receivers, each configured to connect with the stop line circuit of a plurality of discrete manufacturing processes, wherein each of the multi-code receivers is coded with a discrete code.

7. The system of claim 6, wherein a set of multi-code transmitters is coded to communicate with at least one of the plurality of multi-code receivers.
